(19) United States
(12) Patent Application Publication
(10) Pub. No.: US 2012/0099339 A1
(43) Pub. Date: Apr. 26, 2012

(54) LIGHT ENGINE MODULE AND SYSTEM INCLUDING SAME

(75) Inventors: Mark LaPlante, Vergennes, VT (US); Henry Schek, Milton, VT (US); Hugh Spahr, North Ferrisburgh, VT (US); Julie Martin, Monkton, VT (US); Chris Baumann, Milton, VT (US)

(73) Assignee: Chroma Technology Corporation, Rockingham, VT (US)

(21) Appl. No.: 13/276,547

(22) Filed: Oct. 19, 2011

Related U.S. Application Data
(60) Provisional application No. 61/394,682, filed on Oct. 19, 2010.

(51) Int. Cl. F21V 9/16; F21V 7/00; F21V 8/00; F21V 29/00

(52) U.S. Cl. 362/555; 362/583

(57) ABSTRACT

An optical device is for receiving light from a light source, the light source having an emission wavelength. The optical device includes an elongated light guide, a first end of the light guide configured to receive light from the light source; and a phosphor disposed on a second end of the light guide, an excitation wavelength of the phosphor substantially similar to the emission wavelength of the light source. The light guide is formed of a material configured to dissipate at least some heat generated by the light source.

### CROSS-REFERENCE TO RELATED APPLICATIONS

This application claims priority to U.S. Provisional Application Ser. No. 61/394,682, titled “Light Engine Module and System Including Same,” filed Oct. 19, 2010, the contents of which are incorporated herein by reference.

### BACKGROUND

Fluorescence microscopy is a light microscopy technique that can be used to study the structure or properties of a sample by imaging fluorescent or phosphorescent emission from target species, such as organic molecules or inorganic compounds, located on or in the sample. For instance, a sample may be labeled with fluorophores, or molecules that are excited by absorbing light around a specific wavelength (the peak excitation) and, in response, fluoresce, or emit light at a wavelength longer than the peak excitation wavelength. A fluorescence image of the labeled sample can be obtained by detecting the emitted fluorescence.

The light used to excite the sample in a fluorescence microscope generally includes a narrow range of wavelengths so as to avoid spectral overlap with the emission wavelength of the target fluorophores, a situation that would generate optical noise or otherwise interfere with the detection of fluorescence from the sample. Typical light sources used in fluorescence microscopes include xenon and mercury arc-discharge lamps and incandescent halogen lamps. Xenon and incandescent halogen lamps produce white light; mercury lamps also produce white light but have multiple broad emission bands at various wavelengths. Excitation filters are generally used with these light sources in order to restrict the wavelengths of light reaching the sample.

More recently, light-emitting diodes (LEDs) have been used as light sources in fluorescence microscopy. LEDs are semiconductor devices that emit light in a narrow wavelength band. The wavelength of light emitted from an LED depends on characteristics of the LED, such as the semiconductor material from which it is made. LEDs are desirable for use in fluorescence microscopes because the narrow emission wavelength band obviates the need for excitation filters, and because their emission tends to be more stable than emission from arc-discharge or incandescent lamps. LEDs are also preferred for use in fluorescence microscopy because their output can be electronically controlled, unlike filtered wide band light sources such as arc discharge or incandescent lamps.

### SUMMARY

In a general aspect, an optical device is for receiving light from a light source, the light source having an emission wavelength. The optical device includes an elongated light guide, a first end of the light guide configured to receive light from the light source; and a phosphor disposed on a second end of the light guide, an excitation wavelength of the phosphor substantially similar to the emission wavelength of the light source. The light guide is formed of a material configured to dissipate at least some heat generated by the light source.

Embodiments may include one or more of the following.

The light guide is a crystalline light pipe. The light guide is sapphire.

A length of the light guide is sufficient to dissipate at least some heat generated by the light source.

The apparatus further comprises an active cooling system. The active cooling system includes a heat spreader connected to the light guide; an active cooling element configured to remove heat from the heat spreader; and a heat sink connected to the active cooling element. The active cooling element includes a thermal electric cooler.

The apparatus further comprises a heat shield disposed between the light source and the phosphor. The apparatus further comprises a heat sink connected to the light source.

The apparatus further comprises a short pass filter disposed on the second end of the light guide, wherein the phosphor is disposed on the short pass filter. The apparatus further comprises a long pass filter positioned to receive light emitted from the phosphor.

The apparatus further comprises a light director configured to receive light emitted by the phosphor and to cause an angular distribution of the light emitted by the phosphor to become narrower. The light director is a compound parabolic concentrator (CPC). The light director is further configured to remove heat from the light guide.

The apparatus further includes the light source. The light source is an LED. The light source is configured to produce up to 13 W of light.

In another general aspect, a system includes a plurality of light generation modules, each light generation module emitting a beam of light. Each light generation module includes an elongated light guide, a first end of the light guide configured to receive light from a corresponding light source; and a phosphor disposed on a second end of the light guide, an excitation wavelength of the phosphor substantially similar to an emission wavelength of the light source. The light guide is formed of a material configured to dissipate at least some heat generated by the light source. The system further includes a plurality of dichroic mirrors, each dichroic mirror associated with a corresponding one of the light generation modules, the plurality of dichroic mirrors arranged to combine the beams of light emitted by the plurality of light generation modules into an illumination beam.

Embodiments may include one or more of the following.

The system further includes a liquid light guide configured to receive the illumination beam.

Each light generation module is configured to emit light at a different wavelength.

Each dichroic mirror is configured to reflect light emitted by the phosphor of the corresponding light generation module.

The system further includes a control module configured to enable control of an intensity of the beam of light emitted from each of the plurality of light generation modules. The system further includes a control module configured to enable control of a status of each of the plurality of light generation modules.

The system further includes a processor; and a non-transitory computer-readable medium storing instructions for causing the processor to control the plurality of light generation modules.

The system further includes an energy storage device configured to provide power to the light source in at least one of the plurality of light generation modules. The energy storage device is an inductor.

Each light generation module further comprises the corresponding light source.

The use of an optical element including a phosphor having the above characteristics has advantages in a number of applications including fluorescence microscopy. In particular, scientists and laboratory technicians can select a phosphor that is capable of receiving light at a first wavelength and emitting light at a preselected second wavelength different than the first wavelength and substantially similar to the peak excitation wavelength of molecules of a specimen. Because the phosphor has an emission wavelength similar to the peak excitation wavelength of molecules of a specimen to be examined, the LED used to excite the phosphor is not required to emit light at the preselected second wavelength similar to the peak excitation wavelength of molecules of the specimen. Commercially available LEDs that provide sufficient power for exciting the molecules of a specimen may not be available at desired wavelengths. In those circumstances, LEDs that generate sufficient power at those wavelengths generally are custom developed at high cost or lower power LEDs are combined in an array to generate sufficient power.

The use of an optical element including a phosphor allows for the use of less expensive, commercially available LEDs paired with an appropriate phosphor necessary for exciting the molecules of the specimen under test. Thus, scientists and technicians are provided with access to wavelengths necessary to efficiently excite certain fluorophores whose peak excitation wavelength is not substantially similar to the emission wavelength of any existing LED

The system disclosed herein advantageously uses a solid crystalline light pipe to separate the primary and secondary emitter for the purposes of controlling heat flow in and out of the secondary emitter, whose efficiency may be compromised by heat emitted from the LED. In addition, the system provides optical feedback of emitted light to control current supplied to the LED within the light engine module to achieve short term (20 microseconds) and long term (years) stability of the light output. When used in conjunction with an external calibration, the optical feedback system can compensate for changes in other parts of the light generation system.

The disclosed system also provides a lens relay arrangement to deliver light from the modules to the system output, enabling the assembly of a large array of modules into a compact system in which the light from each module is combined into a single beam and focused for coupling into a light guide.

In addition, the light engine module employs non-imaging optics to improve performance of optical filters, and machined optics for mounting of other elements or as heat sinks within the module.

Other features and advantages of the invention are apparent from the following description and from the claims.

### BRIEF DESCRIPTION OF DRAWINGS

FIG. 1 is a partial sectional view of a light engine module.

FIG. 2 is an enlarged view of a portion of FIG. 1.

FIG. 3 is a top plan view of a light engine system.

FIG. 4 is a diagram of the light engine module of FIG. 1 showing divergent light rays emitted from the phosphor.

FIG. 5 is a diagram of the light engine module of FIG. 1 showing a light cone as emitted from phosphor through the forward portion of the module.

FIG. 6 is a graphical user interface for controlling the system of FIG. 3.

FIG. 7A is a front view of the light engine module of FIG. 1.

FIG. 7B is a diagram of a jack screw.

### DETAILED DESCRIPTION

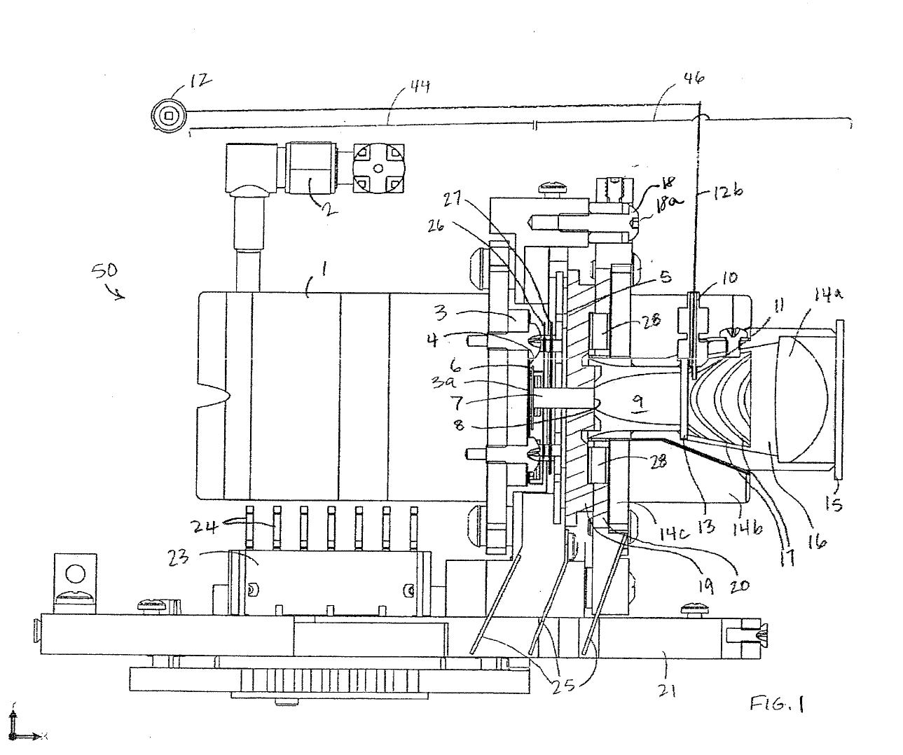

Referring to FIG. 1, a light engine module (LEM) 50 generates light for use with fluorescence microscopy or other imaging applications. LEM 50 includes optical components that generate light and direct the light to a destination, such as a microscope input. LEM 50 also includes components used for the cooling of LED 3a and phosphor 8.

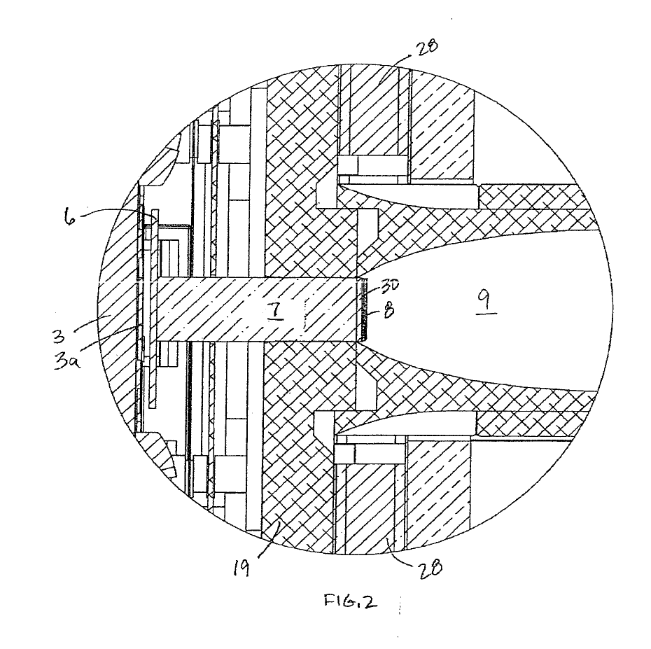

Referring also to FIG. 2, an LED cover 6, such as an LED glass, covers LED 3a. A solid crystalline light pipe 7 (the “rod”) is positioned in contact with LED glass 6. The end of rod 7 that is opposite LED 3a is coated with a phosphor 8. Light emitted by LED 3a propagates along rod 7 and illuminates phosphor 8. The wavelength emitted by LED 3a is substantially similar to the excitation wavelength of phosphor 8. When phosphor 8 is excited by light from LED 3a, the phosphor fluoresces, emitting light at a second wavelength longer than the excitation wavelength. The phosphor may be selected such that its emission wavelength is substantially similar to the peak excitation wavelength of fluorophores in a sample 40 illuminated by LEM 50.

In some embodiments, a cover is not used to cover LED 3a. In this case, if the LED is a die formed of a flip-chip design, rod 7 may interface directly to the die. Rod 7 may also interface directly with an LED if it is possible to avoid wire bonds associated with the LED. Alternatively, an end of rod 7 may float a specified distance above the LED.

### Cooling Mechanisms

LED 3a is a high powered LED 3a capable of emitting, for instance, up to about 13 Watts of light. LED 3a also generates significant amounts of heat. LED 3a is mounted on an LED substrate 3, which in turn is mounted on a heat sink 1. Heat sink 1 provides passive cooling to LED 3a. For instance, air flow through heat sink 1 can remove up to about 100 W of heat. However, not all of the heat generated by LED 3a flows out of the back of the LED and into heat sink 1; some head also radiates forward. The length of rod 7 creates a physical separation between LED 3a and phosphor 8, and provides space for air flow, thus allowing some of the heat from the LED to be disseminated and preventing the heat from poisoning the efficiency of phosphor 8. That is, because phosphor 8 is located at the end of rod 7 farthest from LED 3a, the phosphor is isolated from the heat generated by the LED.

Rod 7 is formed of sapphire, which is a good conductor of heat. In an alternatively embodiment, rod 7 is formed of two different crystals laminated together in series, such as, for instance, a fused-silica portion adjacent LED 3a, and a sapphire portion extending from the fused-silica portion and on which phosphor 8 is coated, enabling the heat performance properties of the rod to be tuned. In still another embodiment, rod 7 is formed of a sapphire portion adjacent LED 3a for heat conduction, and an insulator such as silica extending from the sapphire portion and on which phosphor 8 is coated, further preventing the LED generated heat from heating the phosphor.

In general, rod 7 has a diameter of about 0.120-0.130 inches. In one embodiment, the length of rod 7 is about 0.370-0.380 inches, although longer or shorter rods may also be used. The rod is optically polished on both faces as well as along its length.

In addition to the isolation provided by the length of rod 7, active cooling of the rod and of phosphor 8 is also enabled to dissipate any heat that does arrive at the phosphor. For instance, in some cases, about 8 W of light from LED 3a arrives at phosphor 8, which is only about 3.2 mm in diameter. In particular, rod 7 is embedded into a heat spreader 19 via a tight press fit connection. Heat spreader 19 is formed of a metal such as aluminum and is actively cooled. Heat from LED 3a is conducted along sapphire rod 7 and is cooled by active cooling mechanisms applied to heat spreader 19 before the heat can arrive at the phosphor. Preventing heat from arriving at the phosphor helps reduce or eliminate quenching, in which the emitted light from the phosphor is reduced, e.g., in direct proportion to the temperature rise in the phosphor. That is, for a given LED intensity, as temperature increases, the light emitted from the phosphor drops; as temperature decreases, the light emitted from the phosphor increases. Thermal control and cooling of the phosphor helps to stabilize the temperature of the phosphor, thus enabling light output to be maximized.

Referring again to FIG. 1, heat spreader 19 is cooled by three thermal electric coolers (TECs) 28 that pump heat out of heat spreader 19 and into heat sinks 14b, 14c on a front side 24 of LEM 50. Heat sink 14c is a thick copper base; heat sink 14b is formed of fins extending from that base. A current supplied to TECs 28 causes the TECs to pump heat across their thickness, moving heat quickly into heat sinks 14b, 14c, from which the heat is dissipated into the air. Other components of LEM 50, such as the shape of a lens holder 16, reflectors, and fan speeds, are tuned to enable efficient heat transfer via TECs 28.

Air shunting baffles 25 allow support structures to LED 3a to be constructed below the LED. Three regions of LEM 50 receive air for cooling purposes; the baffles are designed to help air arrive to those regions smoothly.

Two heat shields 26, 27 located between LED substrate 3 and heat spreader 19 provide further cooling capacity. In particular, although most of the heat generated by LED 3a is removed to the back of the LED via heat sink 1, the front of LED 3a still radiates heat like a black body. Furthermore, the surface of LED 3a is much larger than what is generally required for optical use. Heat shields 26, 27 prevent this forward-radiating light and heat from arriving at heat spreader 19 and TECs 28. In particular, heat shield 26 is designed to absorb heat and heat shield 27 is reflective and designed to reflect heat, thus keeping phosphor 8 sequestered from the heat generated by LED 3a. A gap 25a between two of the left-most baffles 25 allows for air to be driven up and through heat shields 26, 27, thus further assisting with the cooling. The use of heat shields 26, 27 to prevent the heat from LED 3a from reaching heat spreader 19 reduces the amount of heat that the TECs must pump into the front heat sinks 14b, 14c, thus allowing smaller TECs to be used.

LEM 50 includes a compound parabolic concentrator (CPC) 9, the rear of which is threaded into heat spreader 19. CPC 9 is machined out of a metal such as aluminum, enabling the threaded connection to plate 19 to be formed in the machining process. In addition, the fact that CPC 9 is machined out of a solid piece of aluminum gives it a solid mass that can be used to aid in the cooling of heat spreader 19. That is, CPC 9 provides extra heat capacity that enables LEM 50 to handle more heat without a corresponding rapid temperature rise, and further provides an extra heat transfer surface in addition to the surfaces of heat sinks 14a, 14b. In an alternative embodiment, CPC 9 is formed of a crystal or plastic that is molded or machined, or electroformed into the appropriate shape. Additional reflective coatings can also be added by processes known in the art.

In the illustrated embodiment, CPC 9 has a parabolic shape in which light enters through the small end and exits through the large end. Other shapes are also possible, including non-parabolic shapes. For instance, a shape could be determined based on an optimization of the light emitted by the phosphor. Alternatively, a double CPC having two parabolas is possible. In general, CPC 9 is a non-imaging optic positioned to receive light from phosphor 8 and that can be configured in any of a number of ways to achieve a desired performance.

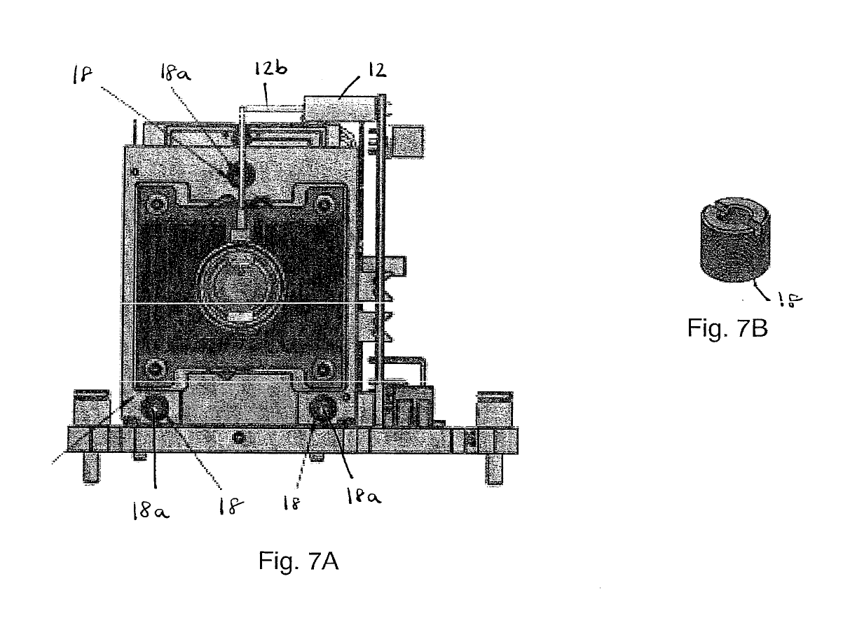

Referring also to FIGS. 7A and 7B, LEM 50 is assembled from two parts: a front half 46 including the solid crystalline light pipe 7 and TECs 28, and a back half 44 including LED substrate 3 and heat sink 1. Three adjustment jack screws 18 are used to join front half 46 and back half 44 such that rod 7 is spaced from LED cover 6 during assembly to prevent damage to the rod. Once LEM 50 is assembled, jack screws 18 are then used to position the halves 44, 46 such that rod 7 is close to or in contact with LED cover 6. The jack screws have a very fine thread and a hole through the center. A screwdriver slot is on the outside face. The three jack screws are screwed in equally to set the spacing between rod 7 and LED cover 6. A separate cap screw 18a is then inserted through the center hole and into the back half to mount and lock the two halves 44,46 together at the desired rod spacing. Adjustment screws 18 can also be used by an operator of LEM 50 to control the position of front half 46 relative to rear half 44 including LED 3a.

LEM 50 includes a connector 2 that allows a voltage signal to be sampled from a circuit board 101 to which LEM 50 is connected.

### Optical Path Through the LEM

The light emitted from LED 3a passes through LED glass 6 and enters sapphire rod 7. Rod 7 acts as a light pipe through which the light is conducted via total internal reflection. The light then passes through a short pass filter 30 disposed on the end of the rod, before reaching the layer of phosphor 8 disposed on filter 30.

A phosphor mix including phosphor 8 is deposited onto filter 30. The phosphor mix includes an encapsulant compound mixed with phosphor crystals. In some cases, the encapsulant compound is silicon based. The phosphor is added to the silicon encapsulant in a particular weight ratio. The weight ratio and thickness are optimized for maximum efficiency. In some cases, the phosphor mix is applied like paint to filter 30; in other cases, the phosphor mix is allowed to settle out of a liquid.

Sapphire rod 7 helps index match the light to the phosphor. In particular, sapphire rod 7 has a much higher index of refraction than glass, and can collect light form a wider range of angles as it leaves the LED glass. In some cases, an index matching glue is used between LED cover 6 and rod 7 to improve the entrance coupling of light into the rod, thus further improving efficiency and making the LED-rod interface mechanically robust.

Short pass filter 30 is also index matched such that a maximum amount of light can be transferred from the sapphire rod, which has a high index of refraction, to the phosphor and encapsulant, which have a generally moderate index of refraction.

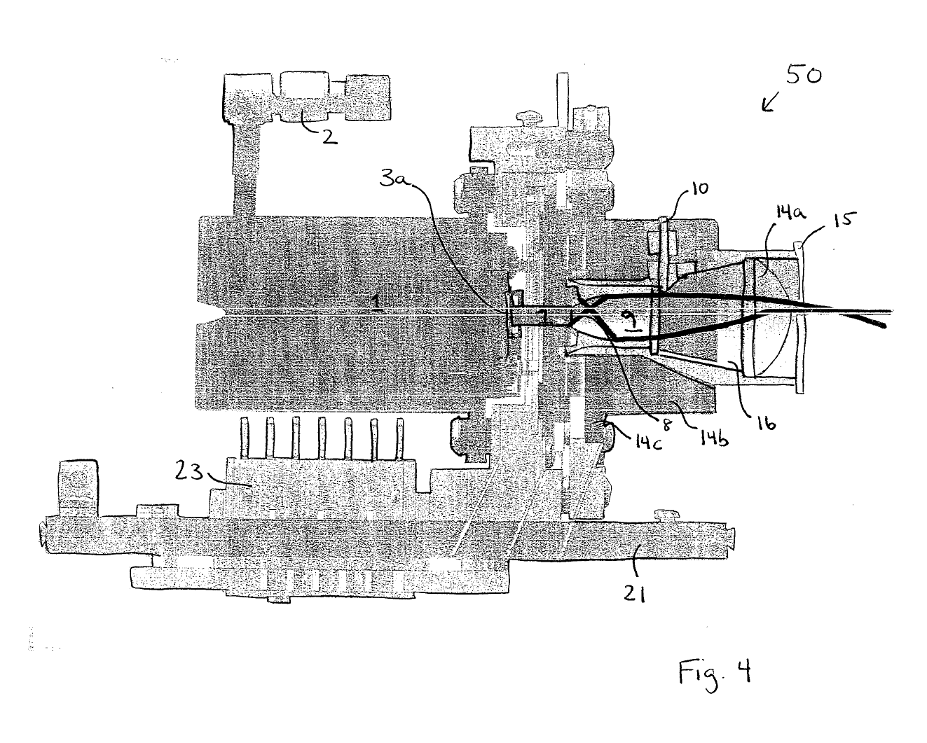

Referring also to FIG. 4, light leaves phosphor 8 in every direction, including backwards towards LED 3a. However, the light emitted by the phosphor has a longer wavelength than the light emitted by the LED, and thus any backwards-propagating light is reflected forwards by short pass filter 30. This arrangement is described in U.S. Patent Publication No. 2009/0201577, the contents of which are incorporated herein by reference. Thus, light emitted from phosphor 8 is directed in all directions within a complete forward-facing hemisphere, i.e., in a 90° half cone. CPC 9 is then used to convert that 90° half cone to a 23.5° half cone in which the light is directed generally straight forwards.

A long pass filter 13 is disposed on the wide end of CPC 9. Filter 13 transmits the long wavelength light emitted from phosphor 8. Ultraviolet light or any shorter wavelength excitation light from the LED is reflected by filter 13 back towards phosphor 8, where it can further excite the phosphor.

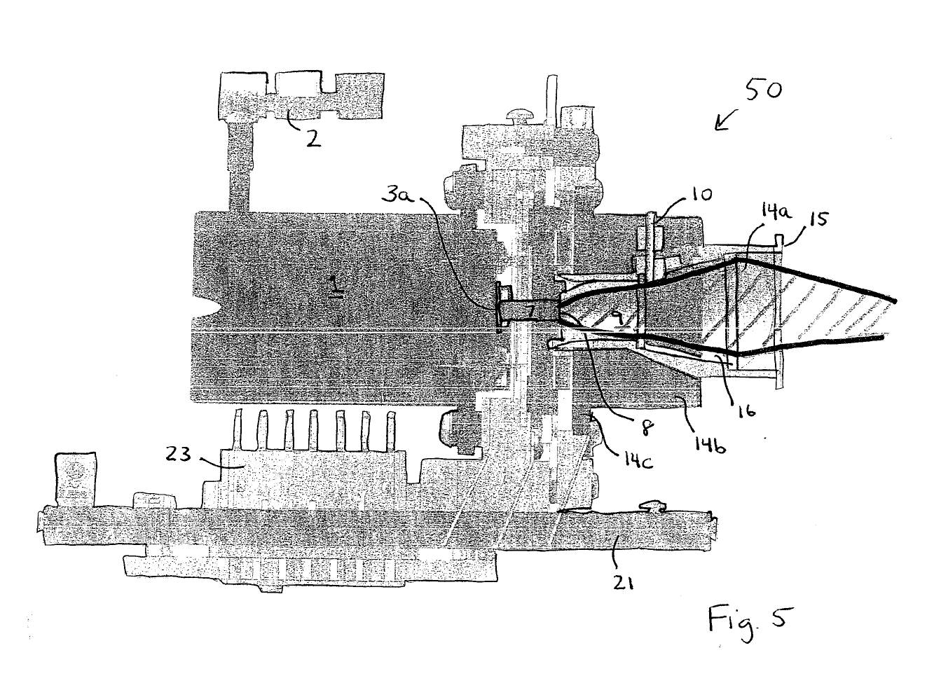

Referring also to FIG. 5, CPC 9 changes the angular distribution of the light rays such that filter 13 can perform more efficiently. In particular, CPC 9 accepts widely diverging rays from rod 7 and redirects the output light into a much narrower range. Because filter 13 is located at the wide end of CPC 9, the filter receives light at an angle that can be efficiently handled by the filter, such as a 23.5° angle Were the filter instead to be located at the narrow end of the CPC, the high angle of the incident light would degrade the efficiency of the filter.

A condenser lens 14a is mounted on a lens holder 16 that mates to CPC 9. Lens 14a produces an angular distribution of light that is appropriate for the relay lens system with minimal reflection or loss of light. Any relay lens used with LEM 50 has an ideal input angle (i.e., an angle beyond which it either reflects light or does not capture light) and an ideal clear aperture (i.e., a diameter over which it can capture light). A trim filter 15 mounted on the outer surface of lens 14a allows a desired wavelength band to be selected.

An optical feedback system including a photodetector 12 (e.g., a fiber optic sensor) receives light from the interior of LEM 50 via an optical fiber 12b held in place by a holder 10. Fiber 12b carries an amount of light that is sufficient to provide information to the photodetector but small enough to have little to no impact on the output of LEM 50. The optical feedback system determines, on the basis of the light from LEM 50, whether the power from the LED is at the right level and thus whether the current to LED 3a should be adjusted up or down. The circuitry associated with this system allows the LED current to be modulated in excess of 1 million times/second, about 1000 times faster than a typical imaging exposure time.

The fins of heat sink 14b are scalloped out of a cone shape to accommodate lens holder 16 (see feature 17 in FIG. 1). A fiber optic holder 10 supported on the top end of filter 13 includes a tiny shield 11 that sits behind fiber 12b. Shield 11 ensures that only forward-propagating light enters fiber 12b, and preventing reflected light from entering the fiber and thus helping photodetector 12 to receive an accurate count of the light emitted from the LEM.

In an alternative embodiment, photodetector 12 is positioned directly on holder 10, increasing robustness and reducing the potential for failure of the photodetector. Fiber optic holder 10 may alternatively be located on either side of lens 14. In a third alternative a single high-speed spectrometer could be used in place of individual photo detectors.

### Multiple LEM System

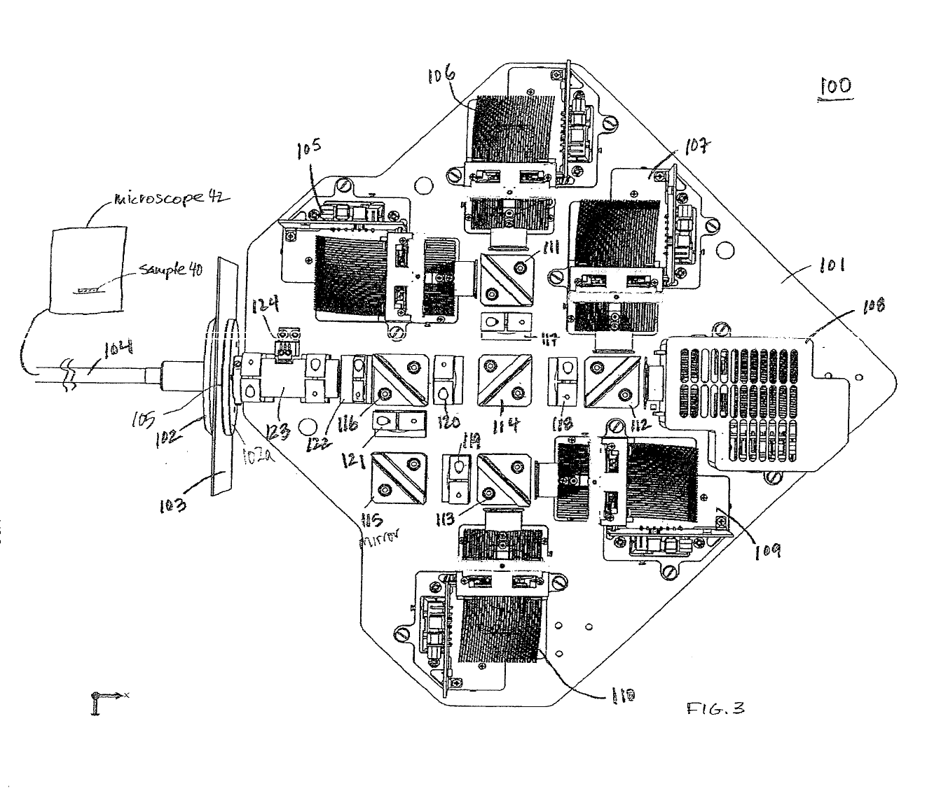

Referring to FIG. 3, a multiple LEM system 100 includes six LEMs 105, 106, 107, 108, 109, and 110, all mounted on a common circuit board 101 and enclosed in a housing 103 (only a cut away portion of housing 103 is shown). In other embodiments, a different number of LEMs could be used.

In the illustrated embodiment, each LEM 105, 106, 107, 108, 109, and 110 generates a different wavelength, with the shortest wavelength provided by LEM 110 and the longest wavelength provided by LEM 108. For instance, the six LEMs may be selected from nine color modules that produce center wavelengths of 405, 430, 480, 500, 530, 555, 585, 640, and 680 nm for biological reporter dyes DAPI, cyan fluorescent protein (fp) or FITC, green fp, yellow fp, Tritc, Orange fp, Texas red, Cy 5, and Cy 5.5, respectively. For other applications, additional color modules that produce center wavelengths as long as 850 nm may be useful. In some cases, an ultraviolet LED may be used in each LEM 105, 106, 107, 108, 109, and 110; in other cases, blue, green, or red LEDs may be used in some or all of the LEMs. In some embodiments, the modules are configurable by a user of the system. For instance, a user studying certain fluorophores may choose to remove the shorter wavelength LEMs and install additional longer wavelength modules.

In system 100, the LEMs are arranged into three pairs 105-106, 107-108, and 109-110. The LEMs in each pair are arranged such that light emitted from one LEM of the pair (e.g., LEM 105) is directed orthogonally to light emitted from the other LEM of the pair (e.g., LEM 106).

Optical components of system 100 collect the light from the multiple LEMs and focus the light into a light guide such as a liquid light guide 104, which in turn delivers the light to a microscope 42 for illumination of a sample 40. Optical components include mirrors 111-116, which may be dichroic mirrors (“dichroics”) or true mirrors, and relay lenses 117-121. Relay lenses 117-121 are achromat lenses, or two lenses glued together at the factory to improve performance with respect to chromatic aberration. In other embodiments, achromatic lenses may not be necessary.

Each dichroic is a long pass dichroic configured to reflect certain wavelengths and transmit other, longer wavelengths, and is associated with one of the LEMs on the basis of the output wavelength of the LEM. One dichroic is positioned at the intersection of the light paths of each orthogonal LEM pair. The dichroic placed closest to a given LEM is not necessarily the dichroic associated with that LEM.

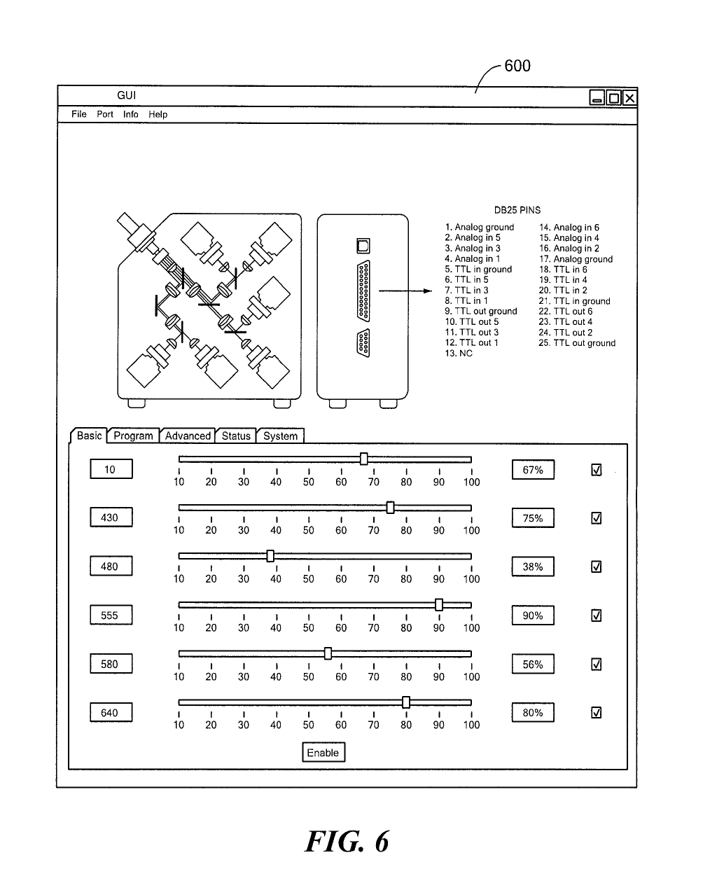

Referring also to FIG. 6, the light path through system 100 is shown. In general, at each point of intersection, two light paths are combined (for example, the light paths from each of LEMs 105 and 106). That combined light path is further combined with a combined light path coming from another pair of LEMs (for example, LEMs 107 and 108), and that combined path is finally combined with light coming from a last pair of LEMs (for example, LEMs 109 and 110). Although FIG. 6 illustrates the light beams as being of constant width, in reality the width of the beams is affected by lenses and other optical components as they pass through system 100.

Examining the light paths more closely, LEM 108 is the longest wavelength module and is placed furthest from liquid light guide 104. Light emitted from LEM 108 does not undergo a reflection and thus there is no dichroic associated LEM 108. Rather, due at least in part to the condenser lens 14a in LEM 108, light exits LEM 108 at an angle appropriate for relay lens 118, and light exits relay lens 118 conditioned for relay lens 120. Similarly, the light exits relay lens 120 conditioned for a condenser lens 120. The remaining LEMs 105, 106, 107, 109, and 110 are similarly configured.

In particular, dichroic 111, which is associated with LEM 105, reflects the output light from LEM 105 and transmits the output light from LEM 106. Relay lens 117 transfers the output light from LEMs 105 and 106 to dichroic 114, which is associated with LEM 106 and which reflects the wavelengths of both LEMs 105 and 106. Dichroic 112, which is associated with LEM 107, reflects the output light form LEM 107 and transmits the output light from LEM 108. Relay lens 118 transfers the output light from LEMs 107 and 108 to dichroic 114, which transmits both wavelengths. The light reflected and transmitted by dichroic 114 passes through relay lens 120 and is transmitted through dichroic 116. Dichroic 113, which is associated with LEM 110 reflects the output light from LEM 110 and transmits the output light from LEM 109. Relay lens 119 transfers the output light from LEMs 109 and 110; the output light is then reflected by true mirror 115 and dichroic 116, which is associated with LEM 109. True mirror 115 is not a dichroic; rather, it is a mirror used to redirect light, thus permitting folding of the system into a smaller volume. No LEM points directly at mirror 115.

The reflected and transmitted light from dichroic 116 includes wavelengths from all six LEM modules. This light then passes through a condenser lens 122, which is similar to lens 14a found in each LEM module, and then through a coupling lens 124 held in a coupling 123. Coupling lens 124 focuses the light onto the surface of liquid light guide 104, matching the input angle and clear aperture of the liquid light guide. In an alternative embodiment, the coupling lens 124 could be replaced by a non-imaging optic. The liquid light guide 104 extends through an opening 105 in housing 103 and is held in coupling 123. Housing 103 provides support and protective covering 102, 102a to the liquid light guide 104 in the vicinity of opening 105. A system lock 124 prevents light form escaping from opening 105 when no liquid light guide is connected to the system.

System 100 is configured such that the distance between successive relay lenses is twice their focal length. The distance that light travels from one end of system 100 to the other is four focal lengths. The system can thus be referred to as a 4F relay. While this is an efficient embodiment, other embodiments using a different optical layout are also possible.

The arrangement of dichroics and lenses in system 100 does not provide magnification or demagnification. Furthermore, the arrangement permits positioning of dichroics such that the lengths of the beam paths permit inclusion of outputs from all LEM modules into a single beam. As a result, system 100 maintains all emitted light in a small volume as the light approaches liquid light guide 104.

System 100 is substantially symmetric, meaning that the system is symmetric in practice, with small deviations for improved performance. That is, the angular distribution of the light upon exit into liquid light guide 104 as it was when it entered lens 14a inside each LEM (i.e., a 24° cone).

The microscope end of liquid light guide 104 (not shown) may interface with additional optical elements to further condition the emitted light. Alternatively, the light exiting liquid light guide 104 may be directed onto a sample without further conditioning.

In some cases, of the 13 W emitted from LED 3a in each LEM, about half arrives at phosphor 8, and each LEM ultimately emits about 1-2 W of wavelength converted light. Of that, up to about 800 mW of light is transmitted through the entirety of system 100 if there are no trim filters in place. If trim filters are used, about 150-500 mW of light is generally emitted from liquid light guide 104, in defined wavelength bands that work well with dyes used in sample 40. These wavelength bands generally range in width from about 15 nm to about 60 nm. Because the system is flexible in terms of dichroic filters and trim filters, a user can customize the wavelength distribution and power output of the system. In addition, power output may increase with the use of more efficient LEDs and/or phosphors.

The liquid light guide 104 may be 3 mm, 5 mm, or up to 8 mm in diameter. In the illustrated embodiment, a 5 mm liquid light guide is used. The liquid light guide may be replaced with a glass, silica, or plastic fiber optic. However, liquid light guides are in general advantageous as compared to solid fiber optics because they are generally large in size, are not bundled fibers and thus do not have void space between individual fibers, and tend to have a larger acceptance angle (i.e., an acceptance angle of 36° is theoretically possible for the liquid light guide, compared with about 18° for a silica fiber).

The acceptance angle of a liquid light guide is generally constant regardless of the diameter of the liquid light guide. With regard to the light arriving at the liquid light guide, if the angular direction of the light is made narrower, the focused spot is in turn made larger. The opposite is also true. This is a simple but accurate explanation of the consequences of a principle known as the area-angle product limit, the optical invariant, or the Etendue of the system. The liquid light guide's acceptance angle and diameter result in the fact that the liquid light guide is the limiting point in the system for this quantity and the system is designed to match this quantity throughout the system to the value of this quantity at the entrance to the liquid light guide. This approach can be viewed as an optimization problem based on etendue matching. Experimental determination of the appropriate configuration can allow other liquid light guide diameters to be used.

In the illustrated embodiment, long pass dichroics are used, such that the LEM producing the shortest wavelength is closest to liquid light guide 104 and the LEM emitting the longest wavelength is farthest from the liquid light guide. In an alternative embodiment, short pass dichroics may be used and this arrangement would be reversed.

In an alternative embodiment, two three-channel systems could be substituted for the illustrated six-channel system 100. For instance, the alternative system may include two three-channel systems, each having its own liquid light guide 104. The liquid light guides from each three-channel system are directed to an appropriate dichroic at the microscope, such that the last combination of light paths is performed at the microscope. In this arrangement, the dichroic at the microscope is selected such that the cutoff wavelength is above the wavelength provided by one of the liquid light guides and below the wavelength provided by the other liquid light guide.

In some cases, the system is fixed directly to a microscope without the use of a liquid light guide.

In an alternative arrangement, the dichroics in system 100 are arranged linearly.

### System Control

The on/off status and the light intensity of the LED in each LEM in system 100 can be controlled. For instance, a user may choose to use no more than four LEMs at any given time. Referring to FIG. 6, user control may be implemented through a user interface, such as a graphic user interface 600 and associated software which allows individual control of each LEM in the system.

The LEDs in system 100 can be controlled through direct, logical pulses. The system is capable of storing programs within its electrical architecture. For instance, the system may have a pre-stored set of instructions ready; every time it receives a digital pulse it executes the next instruction in the set. As an example, a set of instructions may include the following: turn on green LEM, take an image of sample excited by green LEM, turn on red LEM, take an image of sample excited by red LEM, pause, move stage, repeat. Such instructions are powerful tools for research uses of fluorescence microscopes. In these cases, the role of the user's computer is merely to receive and store data and/or images; system 100 handles all of the controls.

The LEDs in system 100 can also be controlled through analog signals to provide proportional power control. For instance, power output is zero for an input setting of zero, 50% for an input setting of 5 volts, and 100% for an input setting of 10 volts. Photodetector 12 (or another sensor) and its associated circuitry allow system 100 to constantly adjust the current to the corresponding LED to maintain a stable power.

The control system may adjust current to the LED at initial start-up of the LEM or continuously during operation to maintain a stable current. Associated control circuitry includes an inductor. Prior to start-up, the inductor is charged (pre-fluxed), and thus has load ready when the switch to the LED is opened. When the LED is turned on, the charge from the inductor passes to the LED to reduce the rise time. The control loop then takes over control and adjusts rise times without massive overshoots. For instance, power can go from 10% to 90% in about 5 microseconds. This feedback system also functions during high speed operation, allowing 10 microsecond rise times to be achieved with less than 5% overshoot. Thus, not only is the feedback used for stability, but also to enable rapid switching between colors. The feedback system also improves performance of the LEDs, thus enabling long-term (e.g., years) efficiency and stability of the system.

In some embodiments, a switching power supply is used for boosting the LED voltage. A calibration routine, for both setup and long term user calibration, may be implemented. In some cases, cooling fans are included in a phase locked loop circuit for noise mitigation.

Although the LEM 50 and system 100 are described in the context of fluorescence microscopy, other applications are also possible. For instance, whole animal studies typically involve fluorescent dyes but often require low or no magnification. System 100 may be used as an illumination source for a whole animal imaging system. Alternatively, system 100 could be used as a light source for in fields such as sequencing, cytometry, or in vivo or surgical imaging.

In some cases, the system 100 is sold as a unit. In other cases, a single LEM module may be sold as an individual light generator and installed by a customer into the customer's own system.

It is to be understood that the foregoing description is intended to illustrate and not to limit the scope of the invention, which is defined by the scope of the appended claims. Other embodiments are within the scope of the following claims.

What is claimed is:

1. An optical device for receiving light from a light source, the light source having an emission wavelength, the optical device comprising:
an elongated light guide, a first end of the light guide configured to receive light from the light source; and
a phosphor disposed on a second end of the light guide, an excitation wavelength of the phosphor substantially similar to the emission wavelength of the light source,
the light guide formed of a material configured to dissipate at least some heat generated by the light source.

2. The optical device of claim 1, wherein the light guide is a crystalline light pipe.

3. The optical device of claim 1, wherein the light guide is sapphire.

4. The optical device of claim 1, wherein a length of the light guide is sufficient to dissipate at least some heat generated by the light source.

5. The optical device of claim 1, wherein the apparatus further comprises an active cooling system.

6. The optical device of claim 5, wherein the active cooling system comprises:
a heat spreader connected to the light guide;
an active cooling element configured to remove heat from the heat spreader; and
a heat sink connected to the active cooling element.

7. The optical device of claim 6, wherein the active cooling element includes a thermal electric cooler.

8. The optical device of claim 1, further comprising a heat shield disposed between the light source and the phosphor.

9. The optical device of claim 1, further comprising a heat sink connected to the light source.

10. The optical device of claim 1, further comprising a short pass filter disposed on the second end of the light guide, wherein the phosphor is disposed on the short pass filter.

11. The optical device of claim 1, further comprising a long pass filter positioned to receive light emitted from the phosphor.

12. The optical device of claim 1, further comprising a light director configured to receive light emitted by the phosphor and to cause an angular distribution of the light emitted by the phosphor to become narrower.

13. The optical device of claim 12, wherein the light director is a compound parabolic concentrator (CPC).

14. The optical device of claim 12, wherein the light director is further configured to remove heat from the light guide.

15. The optical device of claim 1, further comprising the light source.

16. The optical device of claim 15, wherein the light source is an LED.

17. The optical device of claim 15, wherein the light source is configured to produce up to 13 W of light.

18. A system comprising:
a plurality of light generation modules, each light generation module emitting a beam of light, each light generation module comprising:
an elongated light guide, a first end of the light guide configured to receive light from a corresponding light source; and
a phosphor disposed on a second end of the light guide, an excitation wavelength of the phosphor substantially similar to an emission wavelength of the light source,
the light guide formed of a material configured to dissipate at least some heat generated by the light source.
a plurality of dichroic mirrors, each dichroic mirror associated with a corresponding one of the light generation modules, the plurality of dichroic mirrors arranged to combine the beams of light emitted by the plurality of light generation modules into an illumination beam.

19. The system of claim 18, further comprising a liquid light guide configured to receive the illumination beam.

20. The system of claim 18, wherein each light generation module is configured to emit light at a different wavelength.

21. The system of claim 18, wherein each dichroic mirror is configured to reflect light emitted by the phosphor of the corresponding light generation module.

22. The system of claim 18, further comprising a control module configured to enable control of an intensity of the beam of light emitted from each of the plurality of light generation modules.

23. The system of claim 18, further comprising a control module configured to enable control of a status of each of the plurality of light generation modules.

24. The system of claim 18, further comprising:
a processor; and
a non-transitory computer-readable medium storing instructions for causing the processor to control the plurality of light generation modules.

25. The system of claim 18, further comprising an energy storage device configured to provide power to the light source in at least one of the plurality of light generation modules.

26. The system of claim 25, wherein the energy storage device is an inductor.

27. The system of claim 18, each light generation module further comprises the corresponding light source.
